(19) United States
(12) Patent Application Publication
(10) Pub. No.: US 2004/0218701 A1
(43) Pub. Date: Nov. 4, 2004

(54) Protocol agnostic method for adaptive equalization

(76) Inventors: Prashant Singh, Eden Praire, MN (US); Brett Hardy, Chaska, MN (US); Don Grillo, Lakeville, MN (US)

Correspondence Address: PETER SCOTT, INTELLECTUAL PROPERTY LAW DEPARTMENT, LSI LOGIC CORPORATION, M/S D-106, 1551 McCARTHY BLVD., MILPITAS, CA, 95035, US

(21) Appl. No.: 10/425,842

(22) Filed: Apr. 29, 2003

(51) Int. Cl. H04B 1/10

(52) U.S. Cl. 375/350

(57) ABSTRACT

The present invention is a method and system for providing adaptive equalization that is protocol independent. The frequency content of a signal after transmission may be measured, then compared with an ideal frequency content. The comparison of the measured transmitted signal frequency content to the ideal frequency content may determine the amount of frequency dependent attenuation that has occurred. This comparison may be utilized to set proper equalization settings to restore the distorted transmitted signal to its original frequency content.

### FIELD OF THE INVENTION

The present invention generally relates to the field of high speed data transmission, and more particularly to a method and system for restoring transmitted signals corrupted by non-ideal properties.

### BACKGROUND OF THE INVENTION

In many electronic systems, high speed digital data is transmitted across metal traces between integrated circuits of printed circuit boards. Typically, in high speed digital data transmission, signals are often corrupted by non-ideal properties of the transmission channel. Equalization refers to the method by which an electronic receiver may reduce phase, frequency and other distortions to compensate for the difference in attenuation, time delay and the like. Equalization typically utilizes a set of filters that provide an inverse characteristic to the attenuation of the transmission channel. In such a fashion, a distorted signal may be restored to more closely resemble the original signal.

There are two widely known types of equalization. Fixed equalization applies a fixed amount of compensation to every signal. The application of fixed equalization may be accomplished in an easy manner, but the ability to provide optimal restoration of all transmitted signals is limited due to the variance in the distortion of individual signals. Adaptive equalization examines individual signals to determine an amount of compensation necessary to restore the individual signal. Upon determining the amount of compensation required to restore a distorted signal, that same amount of compensation is applied to the signal.

A problem associated with adaptive equalization is the use of a training sequence. A training sequence involves the transmission of a known sequence of binary data. The sequence is examined, and the equalization settings are derived by the amount of distortion experienced by the sequence during transmission. A disadvantage of using a training sequence lies in the dependence upon the digital data coding that is implemented. Training sequence adaptive equalization may be utilized for only a single data transmission protocol, thus cannot be generally applied to various data sequences. Additional types of adaptive equalization utilize assumptions about the loss transmission of the data channel to choose the settings for the equalization filters, however, this method fails when the properties of the channel are different from what was assumed. Consequently, it would be advantageous if a method and apparatus existed which provided the performance of adaptive equalization while being protocol independent.

### SUMMARY OF THE INVENTION

Accordingly, the present invention is directed to a method and system for providing adaptive equalization that is protocol independent. In an embodiment of the invention, a frequency content of data after transmission may be measured. The frequency content of the digital data, before transmission, may be calculated mathematically. The frequency content of the digital data, before transmission, may be the ideal frequency content after transmission. A ratio utilizing the measured post-transmission frequency content may be compared with the ideal frequency content to determine an amount of frequency dependent attenuation that has occurred. The ratio may be utilized to set proper equalization settings to restore the distorted transmitted signal.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 depicts a process for providing adaptive equalization to a transmitted signal in accordance with an embodiment of the present invention;

FIG. 2 depicts a process for restoring a signal in accordance with an embodiment of the present invention; and

FIG. 3 depicts a block diagram of a system for providing adaptive equalization in accordance with an embodiment of the invention.

### DETAILED DESCRIPTION OF THE INVENTION

Reference will now be made in detail to the presently preferred embodiments of the invention, examples of which are illustrated in the accompanying drawings.

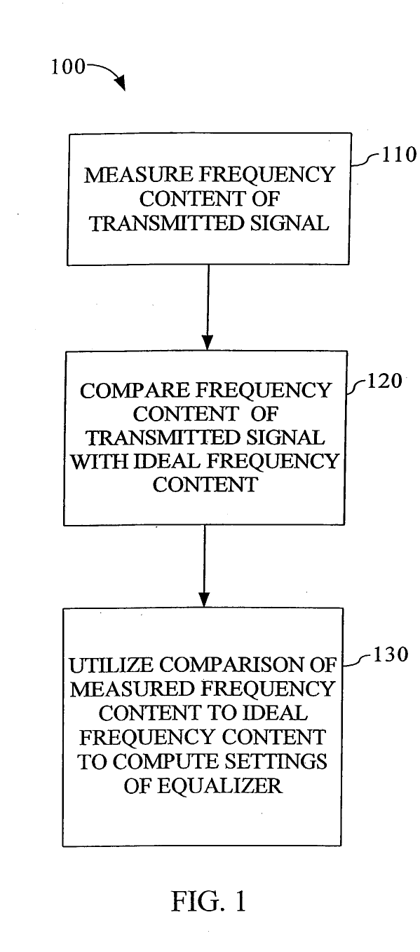

Referring to FIG. 1, a process 100 for providing adaptive equalization to a transmitted signal in accordance with an embodiment of the present invention is shown. Process 100 may begin upon measuring the frequency content of a transmitted signal 110. Binary data, being pseudo-random in nature, may have a particular frequency content. The frequency content of the data may be altered during transmission, consequently it is advantageous to restore the signal to its original frequency content.

The frequency content of the transmitted data may be compared with an ideal frequency content of the transmitted data 120. An ideal frequency content may be the frequency content of the signal that has not been distorted by a transmission channel. The ideal frequency content of the ideal data may be the original frequency content of the digital data prior to transmission. The comparison of the measured frequency content after transmission with an ideal frequency content may be utilized to compute settings of an equalizer to restore a signal to its original frequency content 130. In an embodiment of the invention, the comparison of the measured frequency content to the ideal frequency content may be a ratio, the ratio being utilized to compute filter coefficients of an equalizer.

An advantageous aspect of process 100 is the ability to adaptively equalize individual signals. As a result, individual signals may be optimally equalized according to a detected amount of attenuation. Additionally, process 100 may be protocol independent and accordingly may be applied to various data sequences to remove distortion from the signal.

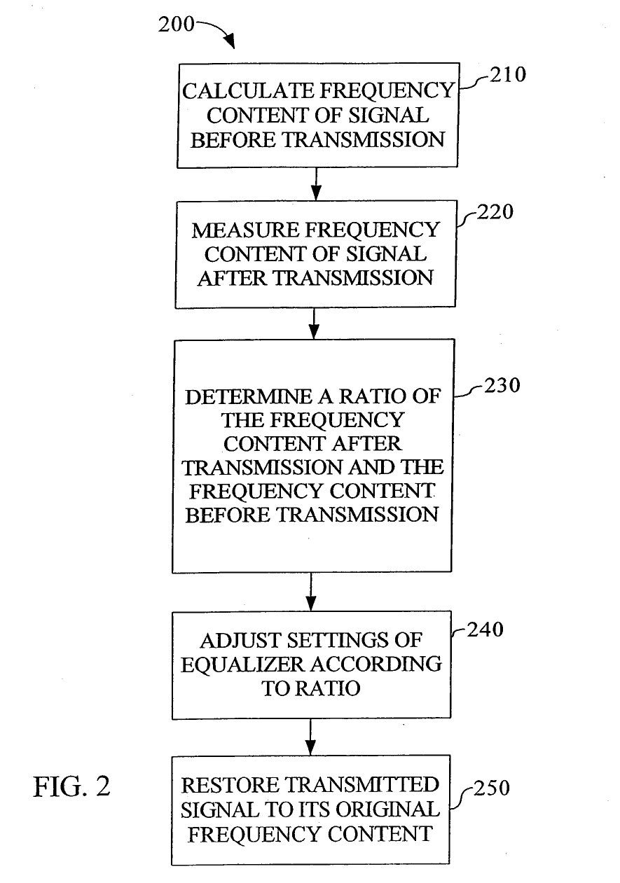

Referring now to FIG. 2, a process 200 for restoring a signal in accordance with an embodiment of the present invention is shown. Process 200 may begin by calculating the frequency content of a signal before transmission 210. This may be accomplished mathematically by employing a Fourier transform. It is contemplated that other methods of calculating the frequency content of binary data may be employed by those with ordinary skill in the art without departing from the spirit or intent of the invention.

The frequency content of the transmitted signal may be measured 220. In an embodiment of the invention, a series of bandpass filters may be employed to determine the frequency content of the transmitted signal. A ratio of the measured post-transmission frequency content to the calculated pre-transmission frequency content may be determined 230. Since the pre-transmission frequency content may be the ideal frequency content of a transmitted signal, the ratio of the received frequency content to the ideal frequency content may be utilized to adjust the settings of an equalizer 240. Upon adjustment of the equalizer, the transmitted signal may be sent through an equalizer to restore the transmitted signal to its original frequency content 250.

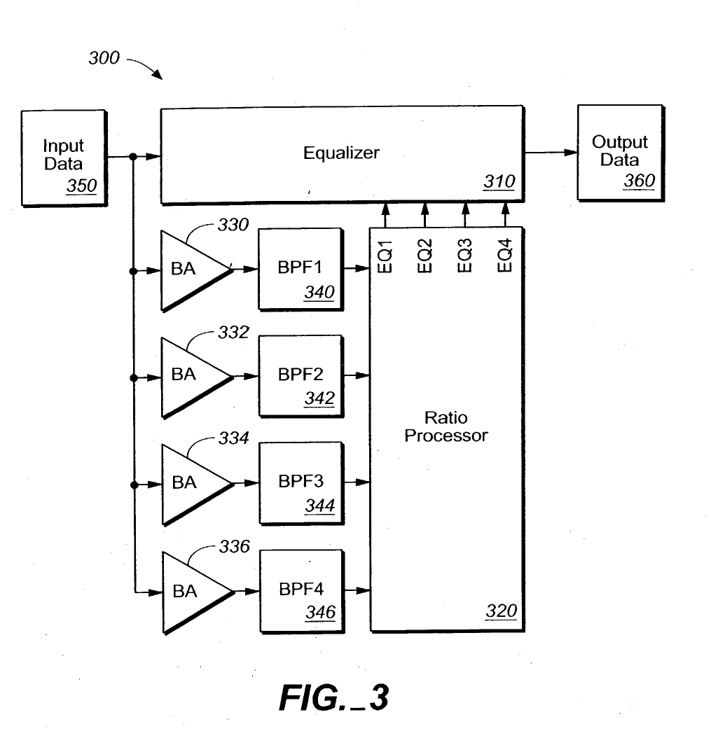

Referring to FIG. 3, a block diagram of a system 300 for providing adaptive equalization in accordance with an embodiment of the invention is shown. System 300 may effectively execute processes 100 and 200 of FIGS. 1-2 to provide adaptive equalization and restore transmitted signals to their original frequency content.

System 300 may include an equalizer 310, a ratio processor 320, a plurality of buffer amplifiers 330-336 and a plurality of bandpass filters 340-346. Input data 350 may refer to the transmitted data signal that has been distorted by a transmission channel. Output data 360 may refer to the adaptively equalized signal that may closely resemble the original frequency content of the digital data being transmitted.

Buffer amplifiers 330-336 may amplify the input data signal that is passed through a series of bandpass filters 340-346 of different frequencies. Each of the bandpass filters 340-346 may sample the frequency content of the input data 350. The ratio processor 320 may analyze the ratios of the frequencies to determine the attenuation that the signal has experienced. While four buffer amplifiers 330-336 and four bandpass filters 340-346 are shown, it should be understood that a lesser number or greater number of amplifiers and filters may be utilized depending upon the degree of accuracy necessary for a particular application.

Ratio processor 320 may be capable of determining the original frequency content of the digital data by performing mathematical calculations, such as the use of Fourier transforms. The ratio processor 320 may output the settings for the equalizer 310. The equalizer 310 may adjust the input data 350 to compensate for the attenuation to provide output data 360 that more closely resembles the original frequency content of the input data 350. In an embodiment of the invention, the transmission channel may be a 2.125 Gb/s Fibre Channel Transmission with a Fibre Channel weighting filter. A set of 4 bandpass filters 340-346, in approximately decade frequency intervals would capture the spectra. The frequency bands may be 1247 kHz-12.47 MHz, 12.47 MHz-124.7 MHz, 124.7 MHz-1.247 GHz, and 1.247 GHz-2 GHz. Advantageously, this may allow detection of the frequency content of the transmitted signal whereby ratio processor may output proper settings for the equalizer 310.

An advantageous aspect of the system 300 of the present invention lies in the analog implementation. This is advantageous because the system 300 may operate indifferently and independently of the digital communications format. Additionally, the analog implementation of system 300 does not require complex digital signal processing circuitry of equalization systems known to the art.

While system 300 has disclosed a plurality of bandpass filters for measurement of the frequency content of the transmitted signal, it should be understood by those with ordinary skill in the art that other types of analog implementations may be utilized in accordance with the present invention without departing from the scope and spirit of the present invention.

It is believed that the system and method and system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for equalizing data distorted by a channel, comprising:
measuring a frequency content of a transmitted signal;
comparing said frequency content of said transmitted signal with an ideal frequency content;
setting an equalizer to restore said transmitted signal to an original frequency content based upon a comparison of said frequency content of said transmitted signal and said ideal frequency content.

2. The method as claimed in claim 1, wherein said ideal frequency content is calculated by analyzing data of a signal prior to transmission to obtain a frequency content.

3. The method as claimed in claim 2, wherein said comparing of said frequency content of said transmitted signal with said ideal frequency content includes determining a ratio of said frequency content of said transmitted signal to said ideal frequency content.

4. The method as claimed in claim 3, wherein said ratio is input into said equalizer.

5. The method as claimed in claim 4, wherein said ratio adjusts filter coefficients of said equalizer to properly restore said transmitted signal.

6. A system for equalizing data distorted by a channel, comprising:
means for measuring a frequency content of a transmitted signal;
means for comparing said frequency content of said transmitted signal with an ideal frequency content;
means for setting an equalizer to restore said transmitted signal to an original frequency content based upon a comparison of said frequency content of said transmitted signal and said ideal frequency content.

7. The system as claimed in claim 6, further comprising means for analyzing data of a signal prior to transmission to obtain a frequency content of said ideal frequency content.

8. The system as claimed in claim 7, wherein said comparing means includes means for determining a ratio of said frequency content of said transmitted signal to said ideal frequency content.

9. The system as claimed in claim 8, wherein said ratio is input into said equalizer.

10. The system as claimed in claim 9, wherein said ratio adjusts filter coefficients of said equalizer to properly restore said transmitted signal.

11. A system for equalizing data distorted by a channel, comprising:
an equalizer for receiving a transmitted signal;
a processor operatively associated with said equalizer, said processor providing at least one control for said equalizer;
a plurality of bandpass filters; said plurality of bandpass filters sampling the frequency content of said transmitted signal; wherein outputs of said bandpass filters are analyzed by said processor to measure a frequency content of said transmitted signal, said processor comparing measured frequency content to an ideal frequency content to calculate the attenuation within the transmitted signal, said at least one control adjusting said equalizer to properly restore said transmitted signal to an original frequency content.

12. The system as claimed in claim 11, wherein said processor calculates said ideal frequency content by analyzing data of said transmitted signal to mathematically frequency content of an undistorted signal.

13. The system as claimed in claim 11, said equalizer including a plurality of filters.

14. The system as claimed in claim 13, said at least one control from said processor representing a value corresponding to a filter coefficient to said plurality of filters.
